(19) United States
(12) Patent Application Publication
(10) Pub. No.: US 2004/0205462 A1
(43) Pub. Date: Oct. 14, 2004

(54) System having a single, robust, universal workflow for the creation, printing, and binding of hardcopy books, and for the accessibility and delivery of electronic books

(76) Inventor: Jonathan D. Levine, Rochester, NY (US)

Correspondence Address: Clarence A. Green, Perman & Green, LLP, 425 Post Road, Fairfield, CT, 06430, US

(21) Appl. No.: 10/041,081

(22) Filed: Jan. 7, 2002

(51) Int. Cl. G06F 17/24; G06F 17/21

(52) U.S. Cl. 715/500; 715/530

(57) ABSTRACT

A workflow and system for print-on-demand book reproduction novelly creates and stores solution-independent master book files so that the master book files are efficiently reproducible by heterogeneous book reproduction workflows and reproduction equipment. The solution-independent master book files are formatted according to an accepted software standard in order to avoid inoperability or poor efficiency with respect to reproduction workflows and reproduction equipment. The workflow and system convert the solution-independent master book files to solution-dependent master book files for compatibility with the reproduction means. The inventive workflow and system are applicable to all manner of book reproduction, including bound hard copies and electronic books.

### 1. FIELD OF THE INVENTION

The present invention broadly relates to methods for efficiently and voluminously reproducing books in both hard copy and electronic forms.

### 2. BACKGROUND OF RELATED ART

Recent advances in computer technology have changed the manner in which books are reproduced, as well as the delivery options available to purchasers. Electronic storage and reproduction allows Book purchasers—whether individuals or large book resellers—to receive large and small print-on-demand orders.

Prior art print-on-demand book workflows involve storing book files (“master book files,” or “master books”) representing the cover and book block (content pages) for later reproduction. The book files can be created by a variety of methods, including commercial book publishing software, and scanning and digitally converting hard copy books into computer files. When a copy or copies of the book is (are) requested, the book files are retrieved from memory, arranged in the proper order, and then printed if a hard copy is requested. For electronic copies, the book files are arranged to reproduce the book, and then delivered to the appropriate destination (e.g., over a communication link such as a wide area network), or made available for retrieval by authorized users.

One noticeable problem with prior art print-on-demand book publishing methods is that while master book files created by one particular publisher/content provider can be efficiently reproduced as books by the same entity because the software has been designed for the particular needs of the content provider, the master book files may not be efficiently reproduced by another entity. The reproduced book—if it is even reproducible by the non-creating entity—may include differences from what was originally intended that are commercially unacceptable. These problems have been observed even when the original content provider and the reproducing entity employ the same basic book publishing software, since the software has often been modified to fit the needs and eccentricities of the particular user, and the files often contain formatting unique to the particular user. The differences in book reproduction workflows are often unintentional, but rather, the result of independent development and modification in response to the environment and demands of the particular user.

The prior art methods of print-on-demand book reproduction can therefore be described as solution-dependent methods. As a result, several versions of the same master book files are often stored in order to accommodate the reproduction needs of multiple foreseeable end users. This is both taxing to system resources as well as inefficient.

What is therefore needed but nonexistent in the prior art, is a robust workflow for creating and reproducing books that efficiently operates with many different types of reproduction systems, while allowing a true copy to be reproduced, delivered or made accessible.

### SUMMARY OF THE INVENTION

In view of the above-identified problems and limitations of the prior art, the present invention provides a print-on-demand method for creating and reproducing books by heterogeneous systems. The method at least includes the steps of receiving as book files, a digital representation of a book targeted for reproduction, converting said book files to have a solution-independent, intermediate format, and storing solution-independent, intermediate formatted book files along with book identification information as a mastered book. The method also at least includes the steps of converting solution-independent, intermediate formatted book files to solution-dependent formatted book files to match the needs of a book reproduction system, and reproducing said book from information comprised by said solution-dependent formatted book files.

The present invention also provides a print-on-demand system for creating and reproducing books by heterogeneous reproduction workflows. The system at least includes a book file generator adapted to generate a digital representation of a book targeted for reproduction, a solution-independent converter adapted to convert said book files to have a solution-independent, intermediate format, and a book file memory adapted to store solution-independent, intermediate formatted book files along with book identification information as a mastered book. The system also at least includes a solution-dependent converter adapted to convert solution-independent, intermediate formatted book files to solution-dependent formatted book files to match the needs of a book reproduction workflow utilized, and a book reproducer adapted to reproduce said book from information comprised by said solution-dependent formatted book files.

The present invention is described in detail below, with reference to the drawings.

### DESCRIPTION OF THE DRAWINGS

Features and advantages of the present invention will become apparent to those skilled in the art from the following description with reference to the drawings, in which:

FIG. 1 is a flowchart detailing the general book mastering and reproduction workflow of the present invention;

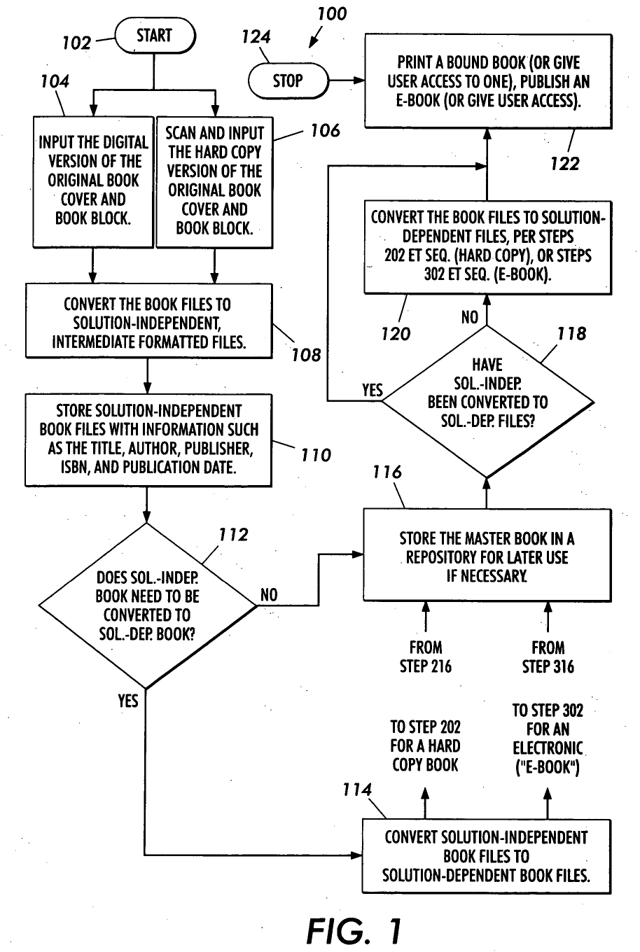

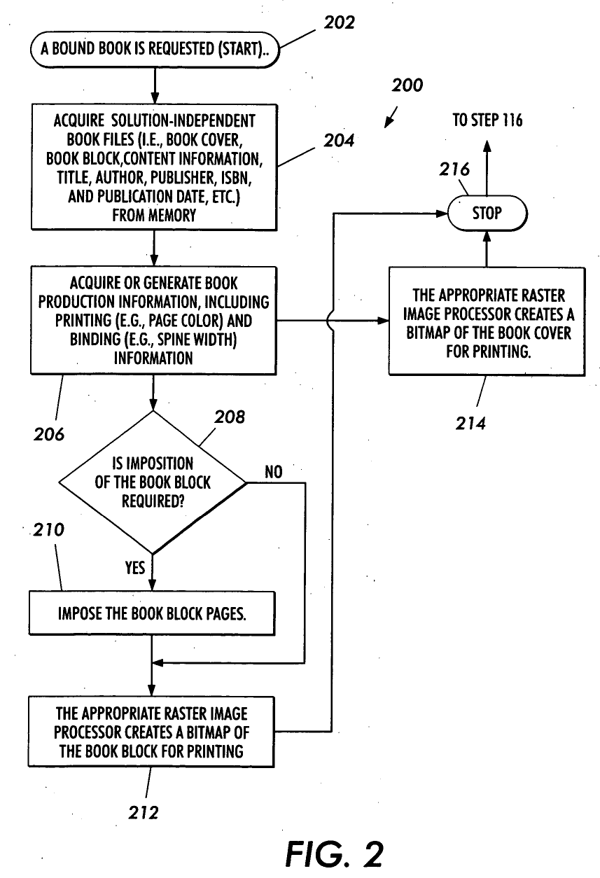

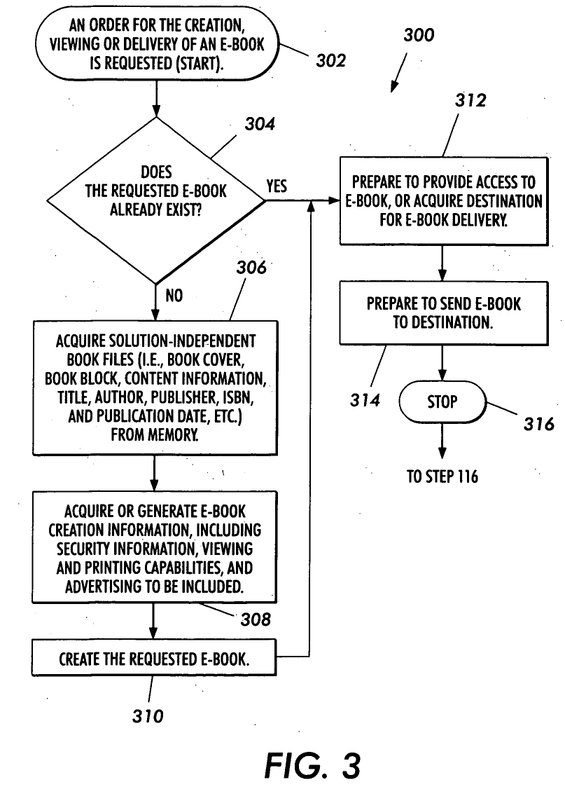

A subset of the flowchart in FIG. 1, FIG. 2 is a flowchart detailing the workflow for converting solution-independent master book files into solution-dependent master book files, as needed, for hard copy reproduction; and

Also a subset of the flowchart in FIG. 1, FIG. 3 is a flowchart detailing the workflow for converting solution-independent master book files into solution-dependent master book files, as needed, for electronic book (“e-book”) reproduction.

### DETAILED DESCRIPTION OF THE PREFERRED EMBODIMENTS

FIG. 1 details the present-inventive workflow adapted to provide a universal book reproduction system for on-demand electronic book retrieval, or bound book printing. The present invention addresses and solves the problems presented by the prior art. With reference to the description, infra., it should be noted that the software used for general book publishing can be one or more of a number of commercially available ones. These include such software packages as Abode Systems' PostScript™ and PDF™, and many others.

The comprehensive on-demand book reproduction workflow 100 of the present invention begins at Step 102. This is followed by inputting the contents of a particular book into memory (Steps 104 or 106). The contents include, inter alia, the book cover and “book block.” The term “book block” refers to the content pages of the book. Step 104 applies when the book is already in digital form, while Step 106 applies when the original book is in hard copy form. The latter step involves scanning the cover and pages of the book using a commercially available optical scanner, and then converting the analog image to a digital representation.

Step 108, the next step, converts the book files obtained in Steps 104 or 106 to solution-independent, intermediate formatted files. In other words, the book files are then in a universal format, devoid of any particulars unique to the administrator of the system. In Step 110 the workflow stores the solution-independent book files with book identification information such as the title, author, publisher, International Standard Book Number (ISBN), and the publication date. In the preferred embodiment, the master book files comprise all of the files and information stored in Step 110, although it will be appreciated by those skilled in the art that are a number of variations on what may constitute the actual master book files.

Some book reproduction users may have reproduction hardware and software that can reproduce the solution-independent master book files directly without any conversions, while other reproduction users may require that the solution-independent master book files be converted to suit their particular requirements. Therefore, Step 112 makes an inquiry as to whether the solution-independent master book files need to be converted to solution-dependent master book files. If the conversion is necessary, the algorithm advances to Step 114. If not, the workflow stores the master book files in a repository for later use if required (Step 116).

The conversion of the solution-independent master book files to solution-dependent master book files is carried out by subroutine 200 in FIG. 2 for books intended to be delivered as bound hard copies. However, the conversion of the solution-independent master book files to solution-dependent master book files is carried out by subroutine 300 in FIG. 3 for books intended to be delivered as electronic books (“e-books”). The solution-independent to solution-dependent conversion steps are discussed below.

When a bound book is requested for the book reproduction, the subroutine 200 is triggered at Step 202. The workflow acquires the solution-independent master book files from memory in Step 204. This is followed by acquiring or generating the appropriate book production information in Step 206. Book production information is that information necessary for the printing and binding of the book, and includes for example, page color and spine width, respectively. Also following Step 204, a Raster Image Processor (RIP) creates a bitmap representation of the book cover for printing in Step 214.

In Step 208 the workflow determines whether the book block needs to be “imposed;” i.e., placed in the proper sequence and layout for reproduction. If book block imposition is needed, it is performed in Step 210. Otherwise, the workflow advances to Step 212, where the Raster Image Processor creates a bitmap representation of the book block. The bitmap representations from Steps 214 and 212 are sent to the printer or printers for printing the requested hard copy. Thereafter, the subroutine stops at Step 216 and returns to Step 116 of the main workflow 100 in FIG. 1.

When an e-book is requested for viewing or delivery, the subroutine 300 in FIG. 3 is triggered at Step 302. If the master book files for the requested book already exist, they are provided to the requester (Steps 304, 312 and 314). If not, the workflow acquires the solution-independent master book files from memory (Steps 304 and 306). Next, the subroutine acquires or generates e-book creation information such as the viewing and printing capabilities of the requester, advertising to be included with the e-book delivery and security information used to control access to the book.

The requested e-book is created from the master book files and placed in a predefined format capable of being accessed by the requester in Step 310. The subroutine then prepares to give the requester access to the e-book (e.g., via the Internet or other wide area network) in Step 312, or prepares to transmit the e-book (e.g., via an Internet web page or e-mail attachment, etc.) in Step 314.

Returning to FIG. 1, the workflow determines in Step 118 whether the solution-independent master files have been converted to solution-dependent master files. If they have already been converted, the workflow reproduces the book in the requested form in Step 122. If not, the workflow converts the solution-independent master files into solution-dependent master files in Step 120 in the same manner as Step 114, et seq. The workflow finishes at Step 124.

Variations and modifications of the present invention are possible, given the above description. However, all variations and modifications which are obvious to those skilled in the art to which the present invention pertains are considered to be within the scope of the protection granted by this Letters Patent.

For example, while the present-inventive workflow has been described for a book reproduction-on-demand environment, other environments are also suitable, such as those involving “just-in-time” inventory practices (also referred to as “book-in-time” for book inventories).

What is claimed is:

1. A print-on-demand method for creating and reproducing books by heterogeneous systems, said method comprising the steps of:
a) receiving as book files, a digital representation of a book targeted for reproduction;
b) converting said book files to have a solution-independent, intermediate format;
c) storing solution-independent, intermediate formatted book files along with book identification information as a mastered book;
d) converting solution-independent, intermediate formatted book files to solution-dependent formatted book files to match the needs of a book reproduction system; and
e) reproducing said book from information comprised by said solution-dependent formatted book files.

2. The method in claim 1, wherein said book in step a) is originally in the form of electronic files.

3. The method in claim 1, wherein said book in step a) is originally in the form of a hard copy, and step a) further comprises the steps of:
scanning the components of said book; and
converting scanned components of said book into said digital representation.

4. The method in claim 1, wherein said book identification information comprises the book title.

5. The method in claim 1, wherein said book identification information comprises the book author.

6. The method in claim 1, wherein said book identification information comprises the book publisher.

7. The method in claim 1, wherein said book identification information comprises the International Standard Book Number.

8. The method in claim 1, wherein said book identification information comprises the book publishing date.

9. The method in claim 1, wherein step d) comprises the step of:
acquiring or generating hard copy book production information.

10. The method in claim 9, wherein said book production information comprises printing information.

11. The method in claim 9, wherein said book production information comprises binding information.

12. The method in claim 1, wherein step d) further comprises the step of:
via a Raster Image Processor, creating a bitmap of the book block.

13. The method in claim 1, wherein step d) further comprises the step of:
via a Raster Image Processor, creating a bitmap of the book cover.

14. The method in claim 1, wherein step d) further comprises the step of:
acquiring or generating hard copy book production information.

15. The method in claim 1, wherein for electronic books, said book production information comprises security information.

16. The method in claim 1, wherein for electronic books, said book production information comprises viewing capabilities.

17. The method in claim 1, wherein for electronic books, said book production information comprises printing capabilities.

18. The method in claim 1 wherein step e) comprises for electronic books, the step of:
providing access to said book via an electronic link.

19. The method in claim 1 wherein step e) comprises for electronic books, the step of:
delivering said book to a predefined destination.

20. A print-on-demand system for creating and reproducing books by heterogeneous reproduction workflows, said system comprising:
a book file generator adapted to generate a digital representation of a book targeted for reproduction;
a solution-independent converter adapted to convert said book files to have a solution-independent, intermediate format;
a book file memory adapted to store solution-independent, intermediate formatted book files along with book identification information as a mastered book;
a solution-dependent converter adapted to convert solution-independent, intermediate formatted book files to solution-dependent formatted book files to match the needs of a book reproduction workflow utilized; and
book reproducer adapted to reproduce said book from information comprised by said solution-dependent formatted book files.

21. The system in claim 20, wherein said book in step a) is originally in the form of electronic files.

22. The system in claim 20, wherein said book in step a) is originally in the form of a hard copy, and said book file generator further comprises:
a book scanner adapted to scan the components of said book; and
a scanned component converter adapted to convert scanned components of said book into said digital representation.

23. The system in claim 20, wherein said book identification information comprises the book title.

24. The system in claim 20, wherein said book identification information comprises the book author.

25. The system in claim 20, wherein said book identification information comprises the book publisher.

26. The method in claim 20, wherein said book identification information comprises the International Standard Book Number.

27. The system in claim 20, wherein said book identification information comprises the book publishing date.

28. The system in claim 20, wherein said solution-dependent converter comprises:
book production information generator adapted to generate hard copy book production information.

29. The system in claim 28, wherein said book production information comprises printing information.

30. The system in claim 28, wherein said book production information comprises binding information.

31. The system in claim 20, wherein said solution-dependent converter comprises:
a Raster Image Processor adapted to create a bitmap of the book block.

32. The system in claim 20, wherein step d) further comprises the step of:
a Raster Image Processor adapted to create a bitmap of the book cover.

33. The system in claim 20, wherein said solution-dependent converter comprises:
a book production information generator adapted to generate hard copy book production information.

34. The system in claim 20, wherein for electronic books, said book production information comprises security information.

35. The system in claim 20, wherein for electronic books, said book production information comprises viewing capabilities.

36. The system in claim 20, wherein for electronic books, said book production information comprises printing capabilities.

37. The system in claim 20 wherein said book reproducer comprises for electronic books:
an electronic link adapted to provide access to said book.

38. The system in claim 20 wherein said book reproducer comprises for electronic books:
an electronic link adapted to deliver said book to a predefined destination.
